(19) United States
(12) Patent Application Publication
(10) Pub. No.: US 2013/0233719 A1
(43) Pub. Date: Sep. 12, 2013

(54) MASKING PROCESS

(71) Applicants: Alexander Mark HOFFMAN, Monte Sereno, CA (US); Thomas Johannessen, San Jose, CA (US)

(72) Inventors: Alexander Mark HOFFMAN, Monte Sereno, CA (US); Thomas Johannessen, San Jose, CA (US)

(73) Assignee: Apple Inc., Cupertino, CA (US)

(21) Appl. No.: 13/598,457

(22) Filed: Aug. 29, 2012

Related U.S. Application Data
(60) Provisional application No. 61/607,515, filed on Mar. 6, 2012.

(51) Int. Cl. C25D 5/02; B29C 45/14; B23K 26/38; B29C 35/08

(52) U.S. Cl. 205/118; 264/400; 264/273; 219/121.69; 219/121.68; 204/242

(57) ABSTRACT

Methods and systems for masking interior surfaces of a part from exposure to a subsequent process. In some embodiments the interior surfaces are threaded. Methods include forming a plugged insert by overmolding a masking plug material into an opening in the insert, the plug being substantially impervious to exposure to a subsequent process. The plugged insert can then be assembled in the part and the part is exposed to the process. Processes can include anodizing, cleaning, machining and laser etch processes. After the process is complete, the plug is removed from the insert, leaving the insert in the part without the plug. The described embodiments describe methods for optimizing masking methods in a production setting. More specifically, embodiments describe methods for automatic insertion and removal of plugs in a part before and after exposure of the part to a process such as anodization.

### CROSS REFERENCE TO RELATED APPLICATION

This application claims priority to U.S. Provisional Patent Application No. 61/607,515, filed Mar. 6, 2012, and entitled “ANODIZATION MASKING,” which is incorporated herein by reference in its entirety and for all purposes.

### FIELD OF THE DESCRIBED EMBODIMENTS

The described embodiments relate generally to methods for optimizing a production process that requires protection of an interior surface of a part from a subsequent operation. More specifically, embodiments describe methods for automatic insertion and removal of plugs in a part before and after exposure of the part to a process such as anodization.

### BACKGROUND

Anodizing is an electrolytic passivation process used to increase the thickness of the natural oxide layer on the surface of metal parts where the part to be treated forms the anode electrode of an electrical circuit. Anodizing increases corrosion resistance and wear resistance and provides better adhesion for paint primers and glues. Anodic films can also be used for a number of cosmetic effects. For example, anodic films are most commonly applied to protect aluminum alloys (although processes also exist for titanium, zinc, magnesium, niobium, and tantalum).

Anodizing changes the microscopic texture of the surface and changes the crystal structure of the metal near the surface. Thick coatings are normally porous, so a sealing process is often needed to achieve corrosion resistance. Anodized aluminum surfaces, for example, are harder than aluminum but have low to moderate wear resistance that can be improved with increasing thickness or by applying suitable sealing substances. Anodic films are generally much stronger and more adherent than most types of paint and metal plating, but also more brittle. This makes them less likely to crack and peel from aging and wear, but more susceptible to cracking from thermal stress.

Formation of the anodic film can alter the shape and dimensions of surfaces that must otherwise remain dimensionally stable. Surfaces such as a threaded portion of an insert (also referred to as a boss) must remain dimensionally intact in order that a screw or other insert can still be readily accommodated. Conventional approaches to protecting, or masking, threaded inserts from being anodized rely upon manual insertion of plugs formed of material, such as silicone, that is pliable and yet resistant to the anodizing operation. Unfortunately, however, the manual insertion of the plugs is both time consuming and since the material used must be pliant, at least some residue is generally left behind resulting in possible poor subsequent fastener insertion that may require an assembly operator to manually clean the threaded portion thereby reducing the assembly efficiency.

Therefore, what is desired are methods and systems that provide efficient and cost effective masking prior to an anodizing procedure and as well as other procedures such as cleaning, machining an operations involving the use of lasers.

### SUMMARY OF THE DISCLOSURE

This paper describes various embodiments that relate to a method for masking portions of a part prior to exposing the part to an operation. In described embodiments, the subsequent operation can be one or more of an anodization, a machining, a cleaning process or a laser process.

Masking a specific area of the part prior to an operation includes providing a plug in an insert, wherein the plug is impervious to aspects of the subsequent operation. Thus, the plug acts as to mask a portion of the insert from aspects of the subsequent operation. In described embodiments, the plug is placed in an opening or aperture of the insert which can be a treaded or unthreaded hole in the insert. In one embodiment, the plug includes a body portion that is embodied within the insert. The body portion of the plug provides protection of the inner surface of the opening of the insert from the subsequent operation. In described embodiments, the plug is provided in the opening of the insert using an overmolding process.

After the plugged insert is assembled, it is placed into an opening in the part prior to the operation. The insert is sized and shaped to correspond to the size and shape of the opening of the part. For example, the insert may be a designed to be placed in the insert by pressing and fitting the insert in the opening of the part. In other cases, the insert may be designed to threadably engage with the opening of the part.

After the plugged insert is placed in the part, the part undergoes the operation. The operation can be any of a number of operations, for example an anodization process, machining operation, cleaning procedure, laser procedure such as a laser etch procedure, etc. In some embodiments, more than one operation is performed. For example, the part may undergo a cleaning procedure, followed by an anodizing process, followed by a machining and laser etch operation, followed by another cleaning and anodizing process.

After the completion of the operation, the plug is removed from the insert. In described embodiments, the plug includes a protruding portion that extends from a surface of the insert and the part and which provides for a mechanism for removing the plug from the insert after the operation. That is, the plug can be grasped, using for example a pick and place robot, at the protuberance and pulled out of the insert and the part, leaving the insert assembled in the part without the plug. In certain embodiments, the plug is made of a sufficiently conformable material such that it can properly mask the interior portions of the insert, but also sufficiently rigid such that the plug can be located and pulled out by the pick and place robot.

The described embodiments allow for the bulk processing of a number of masking plugs useful in a production assembly environment. Specifically, a number of plugged insert pieces may manufactured in bulk separately from the assembly of the insert in the tool. Thus, assembly of the tool will not be slowed down by the manufacture of the plugged insert.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows a flowchart detailing a process in accordance with the described embodiments.

FIGS. 2A-2C show top down views of a selected portion of an exemplary part undergoing a process in accordance with the described embodiments.

FIG. 3A shows one example of a personal computing device in the form of a laptop computer.

FIG. 3B shows an exemplary top case portion of the personal computing device of FIG. 1A as shown in cut away side cross-sectional view.

FIGS. 4A and 4B show an exemplary insert according to one embodiment is shown in top perspective view and cross section, respectively.

FIGS. 4C and 4D show a cross sectional view and top perspective view of plugged inserted into opening of insert, respectively.

FIG. 5 shows a cross sectional view of an embodiment of a plugged insert in accordance with the described embodiments.

### DETAILED DESCRIPTION OF EXAMPLE EMBODIMENTS

Representative applications of methods according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments may be used, and changes may be made without departing from the spirit and scope of the described embodiments.

The embodiments described herein relate to methods and system for protecting selected surfaces in parts which will undergo a process, such as an anodization process. In described embodiments, masking plugs can be placed into inserts prior to installation in a housing such as that used for computing devices. The inserts can be used with fasteners for the outer housing components of a computing device, such as any of the iMac® personal computer, MacBook® laptop computer or iPad® tablet computer manufactured by Apple Inc. of Cupertino, Calif. Although the subject computing device can be a portable computing device, including even portable media players and cellular telephones, it will be readily appreciated that the various embodiments of the present invention disclosed herein can also be used with larger personal computing devices, servers and the like. Furthermore, it will be readily understood that the fasteners of the present invention can also be used in many other embodiments with other consumer products that are not computing devices. As such, the various inventive fastening screws, bolts, nuts and systems provided herein can be extended to a wide variety of other devices and applications, as will be readily appreciated in view of the entire disclosure herein.

Formation of an anodic film can alter the shape and dimensions of surfaces that must otherwise remain dimensionally stable. Surfaces such as a threaded portion of an insert (also referred to as a boss) must remain dimensionally stable in order to be used as a fastener such as a screw. Conventional approaches to protecting, or masking, threaded inserts from being anodized rely upon manual insertion of plugs formed of material, such as silicone, that is pliable and yet resistant to the anodizing operation. Unfortunately, however, the manual insertion of the plugs is time consuming and since the material used must be pliant, at least some residue is generally left behind resulting in possible changes to thread dimensions resulting in poor fastener insertion that may require an assembly operator to manually clean the threaded portion thereby reducing the assembly efficiency.

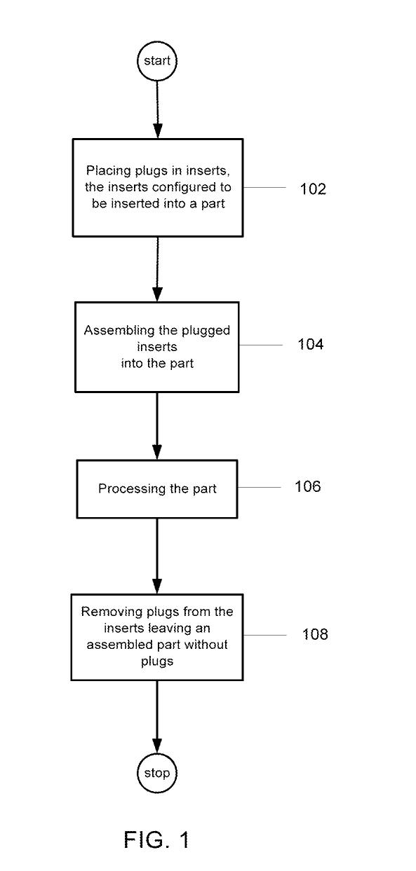

The following provides a description of a mechanism for efficiently providing protection for selected surfaces of a part undergoing a process such as an anodization process. FIG. 1 shows a high level flowchart detailing process steps in accordance with disclosed embodiments. At 102, plugs are placed into openings or apertures of inserts. The inserts are machined pieces that are fabricated to shapes and sizes corresponding to openings in the part. For example, the inserts can be machined to press fit into openings in the part or they can be threaded to threadably engage with corresponding threaded holes in the part. The inserts can function as support structures once assembled in the part. For example, the inserts can be used to support screws that fasten to other structures in the part such as circuit boards and/or brackets. In some applications it can be advantageous for the inserts to be electrically conductive such as when the inserts also function as grounding features. The inserts can be fabricated from a metal or metal alloy, such as aluminum, titanium, titanium, zinc, magnesium, niobium, and tantalum containing materials. In other cases the inserts are made of non-conductive materials such as polymer or silicone containing materials. The inserts each have at least one opening or aperture therein. These openings serve to support a fastener, such as a bolt, which can be threaded or unthreaded. The interior surfaces of the openings are typically the portion of the inserts that are protected from aspects of the subsequent process. For example, in the case where the insert takes the form of a boss, that portion of the interior surface to be protected generally corresponds with a threaded portion suitable for receiving a screw or other such fastener.

The plugs are fabricated from a material which is substantially impervious to the subsequent process, thereby masking a portion of the insert from aspects of the process. In addition the plugs are preferably formed of a material that is capable of conforming to the surface of the insert to ensure proper seal and coverage. If, for example, the subsequent process is an anodization process and the insert is not properly protected, unmasked internal surfaces of the opening of the insert can become anodized, changing the geometry of the opening. A change in internal geometries can compromising the strength of the overall part in cases where geometries are manufactured to fit with high precision, such as for example when the opening is designed to threadably engage with a bolt or screw. In preferred embodiments, the plug material is sufficiently compressible so that the plug can easily be removed by pulling the plug out of the insert once the subsequent process is complete. It is also advantageous for the plug to be sufficiently rigid such that the plug can be easily located by an automated machine such as a pick and place robot. Examples of suitable plug materials include silicone and polymer materials, such as urethane or polyethylene.

In certain embodiments, the plugs are placed in the openings of the insert using an overmolding operation wherein a masking plug material is injection molded into the openings of the inserts where it will harden and become somewhat rigid. In other embodiments, the plug material is pre-formed to fit the opening of the insert and the pre-formed plugs are then inserted in the openings of the inserts. In a manufacturing setting, many inserts can plugged at once, using for example a vibratory feeder to feed the inserts in multicavity trays capable of holding a number of inserts. The overmolding operation can then be applied in the inserts to create batches of assembled plugged inserts. Thus, a large number of plugged inserts can be produced beforehand or in parallel with assembling the inserts in the part. In addition, since the plugged insert assembly can be a separate and independent process, it is easier to inspect and choose plugged inserts based on quality (e.g., proper size, shape and plug coverage) for later insertion in the part.

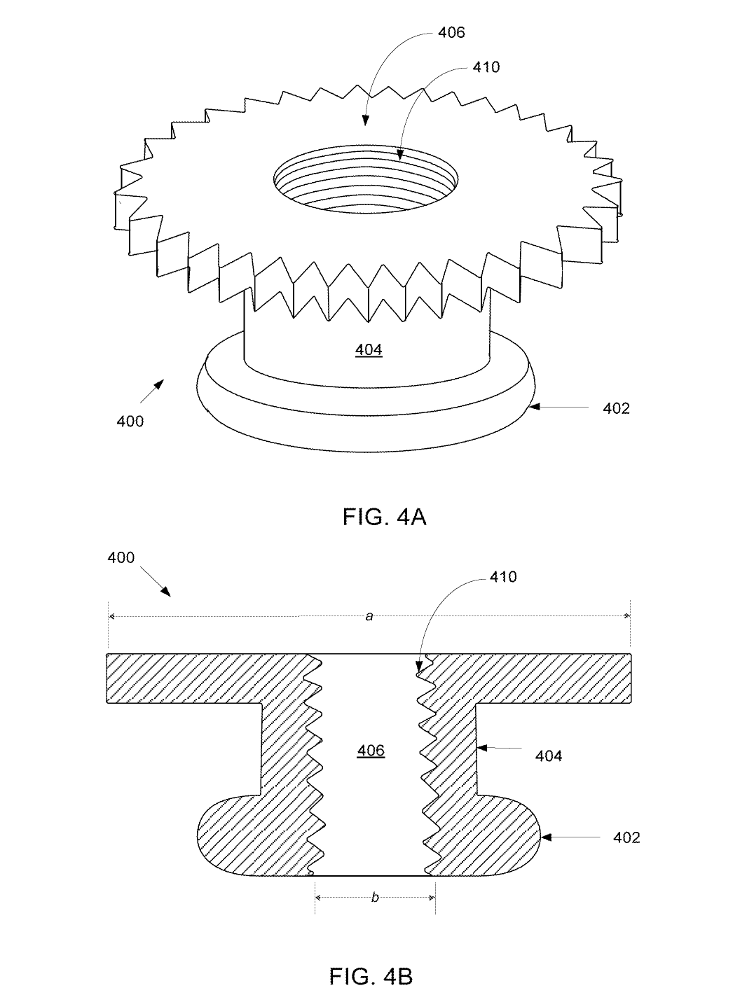

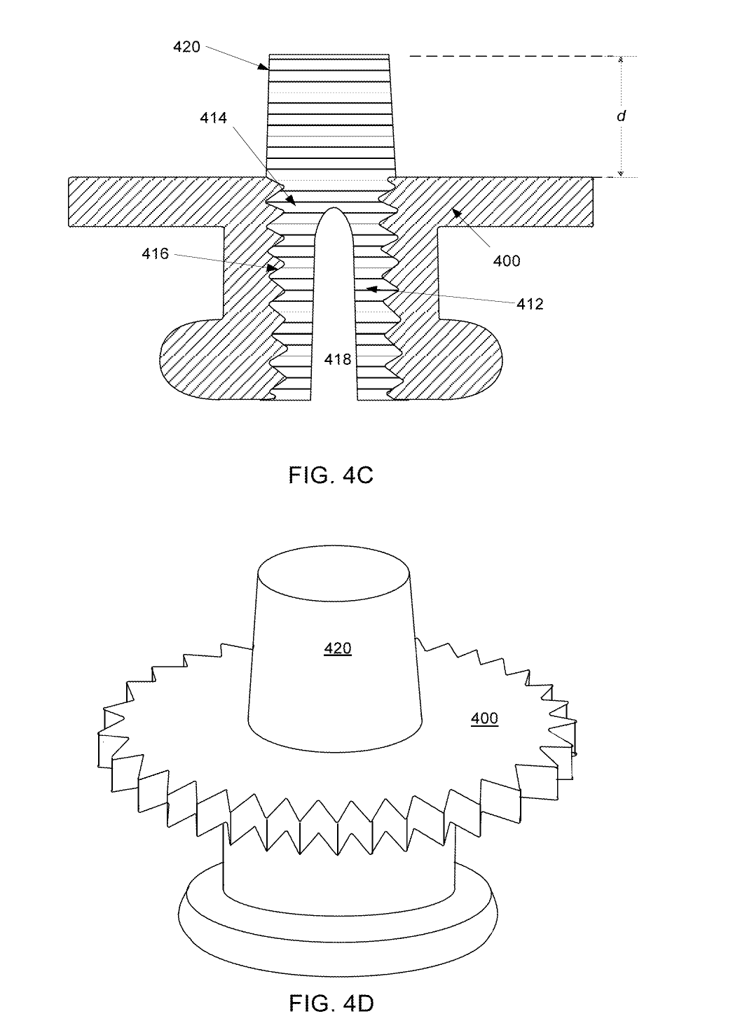

Turning back to FIG. 1, at 104 the pre-formed plugged inserts are then assembled into an opening in the part. As discussed previously, the inserts can be manufactured to press fit into the opening of the part, such as the insert shown in FIGS. 4A-4D, which will discussed in detail later. In alternative embodiments, the inserts can be designed to be screwed into the opening of the part (not shown). In a manufacturing setting, a number of plugged inserts are automatically assembled in the part using for example, a pick and place machine.

At 106, after the plugged inserts are assembled in the part, the part is processed. As discussed previously, the process can be any of a number of processes from which the plug is protecting covered surfaces of the insert. Examples include anodization, cleaning, machining and laser procedures (e.g., laser etch). In some embodiments, the part undergoes more than one operation. For example, the part may undergo a cleaning procedure, followed by an anodization process, followed by laser etch and machining operations, followed by more cleaning and anodization processes. During these processes, the exposed portions of the insert will be exposed to aspects of the processes while the plugged portions of the insert will be substantially unexposed and unaffected.

At 108, upon completion of processing the part, the plugs are removed from the insert, leaving an assembled and processed part without the plugs. In certain embodiments, the plugs are designed to have protruding portions that extend from the surfaces of the inserts. The protruding portions serve as handles such that the plugs can be grasped and removed from the insert. Since the plug material is compressible, the plugs can be grasped by the protruding portions and pulled away from the insert in substantially one motion. In one embodiment, the plug can have a hollow body portion to facilitate the removal of the plug. In a manufacturing setting, a number of plugs are removed automatically using, for example, a pick and place machine. In such instances it can be advantageous for the plug material to be sufficiently rigid such that the plug can be easily located by the pick and place robot. In some instances, the same pick and place machine used to assemble the plugged inserts in the part can be used to remove plugs from the inserts. It should be noted that use of machines, such as pick and place robots, to assemble and remove plugs in a part can allow the use of smaller inserts and plugs. That is, in some cases robotic devices can more easily handle smaller pieces than human hands. This can be an advantage in applications where it is important to keep the dimensions of the overall device small. After the plugs are removed, the processed part can then be fastened to another part via the opening that was protected by the plug. For example, a threaded bolt and matching nut may be used to fasten the part to another part via the opening in the insert.

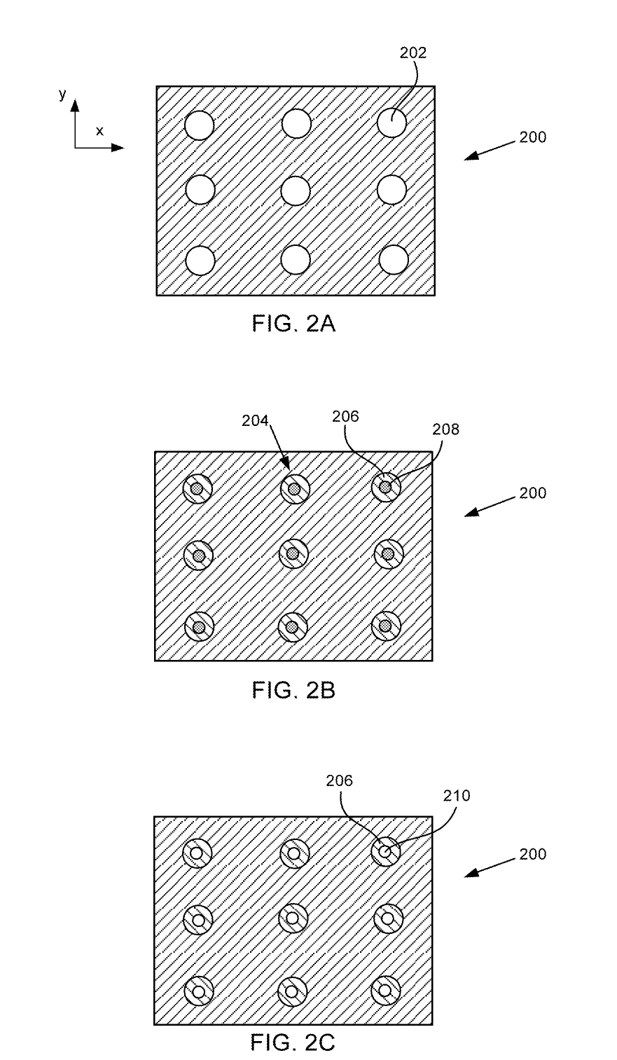

Reference is now made to FIGS. 2A-2C, which show top down views of a portion of an exemplary part being processed in accordance with the described embodiments. FIG. 2A shows part 200 having openings 202 which are manufactured to correspond to the size and shape of the inserts. Openings 202 can be threaded or unthreaded. In some embodiments, openings 202 are configured to allow the inserts to be press fitted therein. At FIG. 2B, the pre-formed plugged inserts 204, which include inserts 206 and plugs 208, are assembled in part 200. Plugged inserts 204 can be automatically assembled in part 200 using a pick and place robot. In some embodiments, plugged inserts 204 are assembled simultaneously in part 200. Plugs 208 have protruding portions which protrude from the surface of part 200 and inserts 206. The protruding portions are configured such that plugs 208 can be easily grasped and pulled from inserts 206. At FIG. 2C, plugs 208 have been removed from inserts 206 and part 200, leaving assembled part 200 without plugs 208. Plugs 208 can be automatically removed using a pick and place robot. In some embodiments, plugged inserts 204 are removed simultaneously from part 200. Insert openings 210, which can be threaded or unthreaded, are configured to accept a fastener, such as a bolt, to fasten part 200 to another part (not shown).

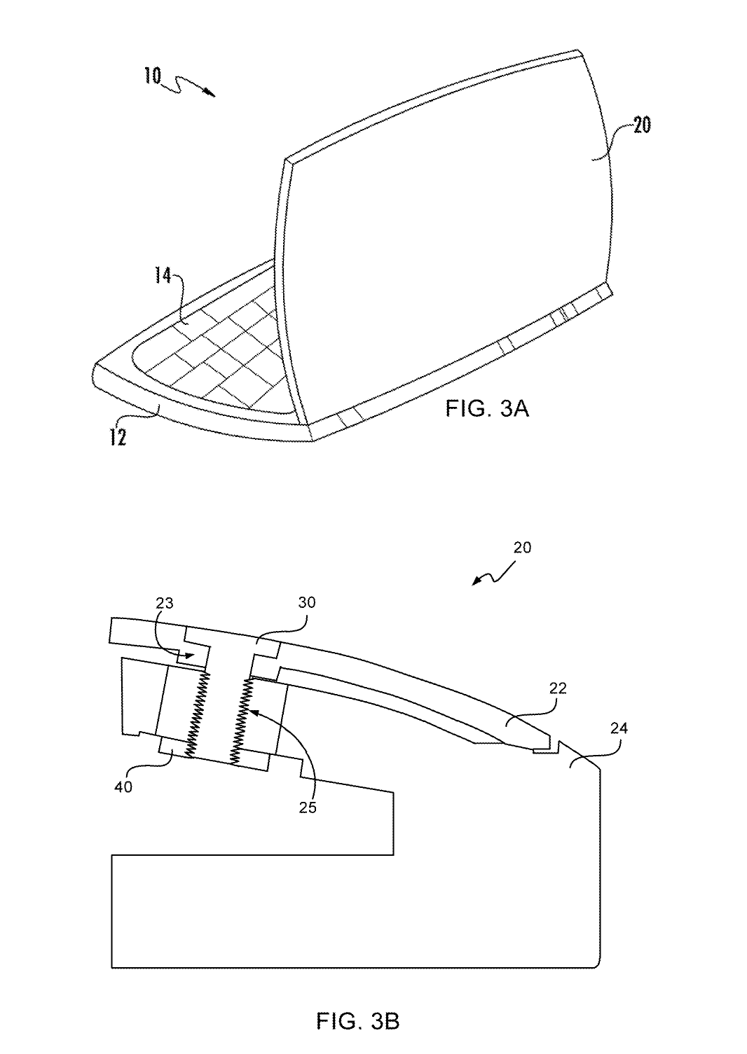

As discussed previously, methods described herein can be used for fastening housing components of a personal computing device. FIG. 3A shows a front perspective view of one example of a personal computing device in the form of a laptop computer, in accordance with the described embodiments. Laptop computer 10 can be, for example, a MacBook® laptop computer, although other brands and models of laptop computers are contemplated for use with the present invention. Laptop computer 10 can have an upper or top case portion 20, as well as a lower or bottom case portion 12 that may include a keyboard 14, touchpad and other various components. Both upper portion 20 and lower portion 12 may include various internal components therein, such as, for example, processors, storage, busses, cards, power supplies, disk drives, displays, I/O interfaces, modems, and the like.

Continuing with FIG. 3B, an exemplary top case portion of the personal computing device of FIG. 3A is shown in cut away side cross-sectional view. Top case portion 20 can include an outer housing base 24 and outer housing cover 22 that is fastened to the base by a number of bolts or screws 30. Such screws 30 can pass through respective openings 23 in housing cover 22 and threaded openings 25 in housing base 24. A threaded nut 40 or other component can be fastened onto the far threaded end of bolt or screw 30 after it is inserted, so as to hold the screw in place. This arrangement shown in FIG. 3B can be repeated numerous times for a number of screws 30 and aligned openings 23, 25, such that the housing cover 22 is then firmly attached to the housing base 24 in a removable manner. As noted above, the use of numerous screws and aligned openings can result in the need for tight tolerances with respect to the size and location of such items. For example, the location of hole 23 should typically be well aligned with respect to hole 25, such that the screw 30 can be properly inserted into both. While only one instance is shown for purposes of illustration, it will be readily appreciated that such holes need to be well aligned for each instance of multiple screws 30 and holes 23, 25 across top case portion 20. While the issue of tighter part tolerances may not be much of a problem for relatively inexpensive and commercially available screws, such tight tolerances can raise costs with respect to the mass production of the housing cover 22 and housing base 24, with their respective sets of holes 23, 25. Because threaded screws and threaded nuts or openings tend to result in tight fits in many standard and commercially available variations, it is imperative that the holes 23, 25 maintain their dimensional integrity throughout the finishing process.

Turning now to FIGS. 4A and 4B showing an exemplary insert 400 according to one embodiment is shown in top perspective view and cross section, respectively. Insert 400 can be a press fit insert in that press fit 400 can be pressed into a hole in a housing. In other embodiments not shown, the insert can be configured to be threadably inserted in a hole in a housing. In any case, insert 400 can include a base 402 and body 404 having an opening 406 there-through that is used for purposes of screw fastening. Insert 400 can be of any suitable size depending on the size of the corresponding part and application requirements. In one embodiment, the top diameter a of the insert is about 3 mm and the opening diameter b is about 1 mm. A threaded fastener such as a screw can be fitted through the opening 406 and secured in place by way of threads 410. In order to assure a secure fit, the dimensions of threads 410 must remain stable. Methods described herein provide ways to cover and protect threads 410 from aspects of a subsequent process, such as an anodizing process, that would otherwise change the dimensions of threads 410.

FIGS. 4C and 4D show a cross sectional view of and top perspective view, respectively, of plug 412 inserted into opening 406 of insert 400. Plug 412 can include body 414 formed of compressible and resilient material that is also resistant to a subsequent process, such as an anodizing process. Body 414 can take the form of threads 416 so as to protect threads 410 of insert 400. In one embodiment, body 414 can be substantially solid. In one embodiment, body 414 can have cavity 418 formed therein to facilitate the removal of plug 412 after a process is performed. In one embodiment, plug 412 can include a protruding portion 420 having a size and shape that facilitates automatic removal of plug 412 from opening 406 after completion of the process. Protruding portion 420 can be any shape and size, and extend any distance d from the surface of insert 400, to accommodate removal of plug 412. In one embodiment, protruding portion 420 extends about 4 mm from the surface of the insert. In one embodiment, plug 312 can be formed by overmolding plug 312 into opening 306. The overmolding process can be done using a machine or done manually. Plug can be automatically removed using an apparatus such as a pick and place robot or can be removed manually.

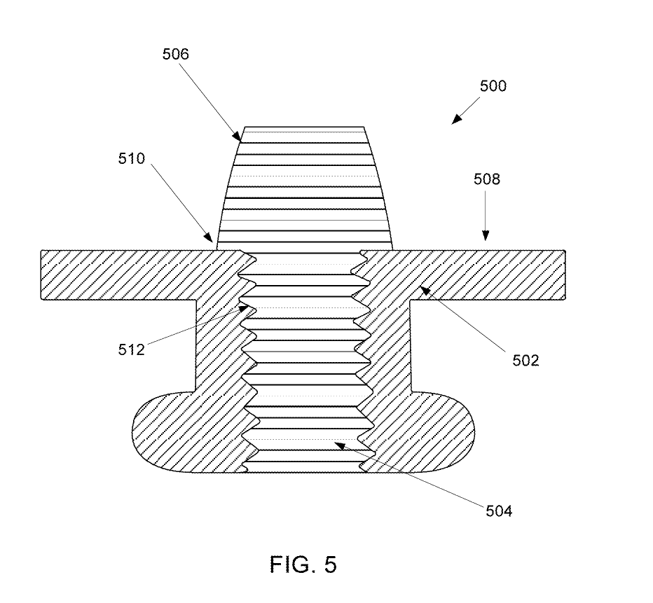

FIG. 5 shows another embodiment of a pre-formed plugged insert 500 in accordance with described embodiments. Insert 502 has plug 504 formed therein. Protruding portion 506 of plug 504 extends a distance from the top surface 508 of insert 504. Protruding portion 506 facilitates grasping and removal of plug 504 from insert 502 after a process is complete. An overshoot portion 510 of plug 504 extends over part of the top surface 508 of insert 502. Overshoot portion 510 can be formed by injected more overmolding plug material over the top surface 508 during the overmolding process. Overshoot portion 510 can be used to assure that threads 512 of insert 502 are sealed and protected from aspects of the subsequent process. Overshoot portion 510 can extend and cover over any amount of top surface 508 of insert 502. In one embodiment, overshoot portion 510 covers and protects the entire top surface 508 of insert 502. In other embodiments, overshoot portion 510 is minimized so that a maximum amount of top surface 508 is exposed to the subsequent process.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for processing a part, the part suitable for receiving a plug assembly in an aperture formed in the part, the method comprising:
forming a process assembly by placing the plug assembly in the aperture, the plug assembly comprising an insert having a size and shape in accordance with the aperture and a plug sized to fit in an opening of the insert, wherein the plug is formed of a material that is substantially impervious to the process such that the plug protects an interior surface of the opening from the process;
operating on the process assembly by the process; and
subsequent to the operating, removing only the plug from the insert leaving the insert in the part aperture.

2. The method as recited in claim 1, wherein the interior surface of the opening is threaded and the plug protects the geometry of the threads from exposure to aspects of the process.

3. The method as recited in claim 1, wherein the process comprises an anodization process.

4. The method as recited in claim 3, wherein the process further comprises at least one of a cleaning, machining, laser etch and additional anodization process.

5. The method as recited in claim 1, wherein the plug assembly is formed by overmolding a plug material in the opening of the insert.

6. The method as recited in claim 1, wherein the forming, operating and removing are performed in bulk with a plurality of plug assemblies placed in a plurality of apertures in the part.

7. The method as recited in claim 4, wherein the process comprises an additional anodization process.

8. The method as recited in claim 1, wherein a portion of the plug covers at least a portion of a second surface of the insert, the second surface separate from the interior surface of the opening of the insert.

9. The method as recited in claim 1, wherein a portion of the plug protrudes a distance from the surface of the insert thereby forming a protuberance of the plug assembly.

10. The method as recited in claim 9, wherein removing the plug from the insert comprises grabbing and pulling the protuberance with a pick and place robot.

11. The method as recited in claim 1, wherein the insert is sized and shaped in press and fit manner in accordance with the aperture.

12. The method as recited in claim 1, wherein the plug comprises a polymer material.

13. A method for processing a part in bulk, the part suitable for receiving a plurality of plug assemblies in a plurality of apertures in the part, the method comprising:
automatically placing the plurality of plug assemblies in the plurality of apertures, the plurality of plug assemblies each comprising an insert having the size and shape in accordance with the plurality of apertures and a plug sized to fit in an opening of the insert, wherein the plug is formed of material substantially impervious to a process such that the plug protects an interior surface of the opening from the process;
processing the part with the plurality of plug assemblies placed therein according to the process; and
automatically removing only the plugs from the inserts leaving the inserts in the part apertures.

14. The method as recited in claim 13, wherein automatically removing the plugs from the inserts comprises pulling out the plugs using a pick and place robot.

15. The method as recited in claim 13, wherein the fabricating the plurality of plug assemblies comprises overmolding a plug material over a plurality of inserts using a multicavity compartment capable of holding a plurality of inserts.

16. The method as recited in claim 13, wherein the process comprises an anodization process.

17. The method as recited in claim 16, wherein the process further comprises at least one of a cleaning, machining, laser etch and additional anodization process.

18. A system for processing a part, the part suitable for receiving a plurality of plug assemblies in a plurality of apertures formed in the part, comprising:
a plugging mechanism for forming the plurality of plug assemblies, the plurality of plug assemblies each comprising an insert having a size and shape in accordance with the plurality of apertures and a plug sized to fit in an opening of the insert, wherein the plug is formed of a material that is substantially impervious to the process such that the plugs protect an interior surface of the openings from the process;
a placing mechanism for placing at least a portion of the plurality of plug assemblies into the plurality of apertures;
a reactor for processing the part; and
a removing mechanism for removing only the plugs from the inserts, leaving the inserts in the part apertures.

19. The method as recited in claim 18, wherein the plugging mechanism is an overmolding mechanism configured to inject a polymer material into the openings of the inserts.

20. The method as recited in claim 18, wherein the plug material comprises a compliant polymer material.

21. The method as recited in claim 18, wherein the placing mechanism is a press fit mechanism configured to press the plug assemblies into the apertures in the part.

22. The method as recited in claim 18, wherein the reactor is an anodization apparatus configured to anodize exposed surfaces of the part.

23. The method as recited in claim 18, wherein one of the placing mechanism and removing mechanism comprises a pick and place robot.

24. The method as recited in claim 18, wherein the placing mechanism and the removing mechanism utilize the same tool.
